(19) United States
(12) Patent Application Publication
(10) Pub. No.: US 2024/0001226 A1
(43) Pub. Date: Jan. 4, 2024

(54) Device and Method for the Vehicle-Optimized Representation of the Relevant Content of a Video Game via a Plurality of Output Units

(71) Applicant: Bayerische Motoren Werke Aktiengesellschaft, Muenchen (DE)

(72) Inventors: Thomas BENEDEK, Muenchen (DE); Christian LOEBEL, Ismaning (DE)

(21) Appl. No.: 18/201,889

(22) Filed: May 25, 2023

(30) Foreign Application Priority Data
Jul. 1, 2022 (DE) 10 2022 116 466.7

(51) Int. Cl. A63F 13/26; G06F 3/14; G06F 9/451; B60K 35/00

(52) U.S. Cl. CPC A63F 13/26; G06F 3/1423; B60K 2370/165; B60K 35/00; B60K 2370/1523; G06F 9/452

(57) ABSTRACT

A device includes a display adaptation unit, which is configured to adapt a video game for output via at least two output units in a vehicle via identification of the gaming content of the actual video game; assignment of gaming content to the primary output unit of the vehicle; identification of additional information content of the video game; exporting of the additional information content of the video game to a virtual desktop; and assignment of the virtual desktop to an auxiliary output unit of the vehicle. The device also includes a control unit, which is configured to control the primary output unit to deliver an output of gaming content, and to control the auxiliary output unit to deliver the output of the additional information content of the virtual desktop which is assigned thereto.

### CROSS REFERENCE TO RELATED APPLICATION

This application claims priority under 35 U.S.C. § 119 from German Patent Application No. 102022116466.7, filed Jul. 1, 2022, the entire disclosure of which is herein expressly incorporated by reference.

### BACKGROUND AND SUMMARY OF THE INVENTION

The present invention relates to a device and a method for the vehicle-optimized representation of the relevant content of a video game via a plurality of output units of a vehicle.

State-of-the-art vehicles comprise one or more output units. In particular, these include vehicle displays or indicator units. Typically, particularly within the field of vision of the driver of the vehicle—additionally to a main display of an in-vehicle infotainment system—further display units such as, e.g. a multimeter, a head-up display, etc., are located. At the same time, as the level of automation of vehicles increases, it is increasingly relevant that the driver of the vehicle should be able to occupy driving time, during which the function of the driving of the vehicle can be entirely assumed by the vehicle, with infotainment content, particularly with the playing of video games or computer games. During waiting times for the charging of an electrical energy store of an at least partially electrically-powered vehicle, the provision of in-vehicle computer games is of particular relevance for the driver of the vehicle. At the same time, vehicle screens of an in-vehicle infotainment system are typically of limited dimensions. The representation of a video game or computer game which is known from the prior art is limited by the dimensions of the in-vehicle display. In addition to the actual video game or computer game, popular games also include the display of further elements of content, for example a current points rating or score, information on other players, a current ranking of the player, etc. The representation of these further elements on the vehicle display further restricts available space for the representation of actual gaming content. Such a representation may be perceived by the user of the vehicle as inconvenient, as the gaming experience is restricted.

The object of the invention is the provision of a solution which permits a vehicle-optimized representation of the relevant content of a video game.

This object is fulfilled by the features of the claimed invention.

The above-mentioned object is fulfilled by a device for the vehicle-optimized representation of the relevant content of a video game via a plurality of output units in a vehicle, comprising:
a display adaptation unit, which is designed to adapt the video game for output via at least two output units in the vehicle, comprising:
identification of the gaining content of the actual video game;
assignment of gaming content to a primary output unit of the vehicle;
identification of additional information content of the video game; exporting of additional information content of the video game to a virtual desktop; and
assignment of the virtual desktop to an auxiliary output unit of the vehicle; and
a control unit, which is designed:
to control the primary output unit, such that the primary output unit delivers the output of gaming content; and
to control the auxiliary output unit, such that the latter delivers the output of the additional information content of the virtual desktop which is assigned thereto.

In the context of the present document, the term “vehicle” includes moveable devices for transport which are employed for the conveyance of persons (passenger traffic), goods (goods traffic) or equipment (machines or tools), and which can be propelled by a combustion engine, or are at least partially electrically powered (electric cars or hybrid vehicles).

The vehicle can be controlled by a vehicle driver. Additionally or alternatively, the vehicle can be an at least partially automatically driven vehicle. In the context of the present document, the terms “automatically driven vehicle” or “automated vehicle” can be understood as driving with automated longitudinal or lateral guidance, or as autonomous driving with automated longitudinal and lateral guidance. Automated driving can include, for example, prolonged travel on a motorway, or time-limited driving in the context of parking or manoeuvring. The term “automated driving” includes automated driving with an arbitrary degree of automation. Exemplary degrees of automation are assisted driving, partially automated, highly automated or frilly automated driving. These degrees of automation have been defined by the Federal Highways Agency (“Bundesanstalt für Straßenwesen” or “BASt”) (see BASt publication “Research abstracts”, November 2012 edition). In assisted driving, the driver is continuously responsible for longitudinal or lateral guidance, whereas the system respectively assumes other functions, within certain limits. In partially automated driving, the system assumes longitudinal and lateral guidance for a certain time and/or in specific situations, wherein the driver is continuously required to monitor the system, as per assisted driving. In highly automated driving, the system assumes longitudinal and lateral guidance for a certain time, without the necessity for the continuous monitoring of the system by the driver; however, the driver must be capable of assuming control of the vehicle within a certain time interval. In fully automated driving, the system, in a specific application, can automatically assume the management of driving in all situations; in this application, a driver is no longer necessary. The above-mentioned four degrees of automation correspond to SAE Levels 1 to 4 as per SAE standard SAE J3016 (SAE—Society of Automotive Engineering). SAE J3016 further provides for SAE Level 5 as the highest degree of automation, which is not included in the definition applied by the BASt. SAE Level 5 corresponds to driverless driving, in which the system is automatically capable of the management of all systems throughout the entire journey, in the same way as a human driver.

The device comprises a plurality of output units, which are designed for the visual or audio-visual output of information content in the vehicle.

A video game or computer game, in a manner which is known from the prior art, can be streamed and/or downloaded into the device or the vehicle via a backend facility, and saved in a memory unit for the playback of the video game.

To this end, the device or the vehicle can comprise a communication unit. The communication unit can comprise a Subscriber Identity Module or SIM card, the function of which is the set-up of a communication link via a wireless system or wireless network. The Subscriber Identity Module unambiguously identifies the communication unit in the wireless network. The communication link can be a data connection (e.g. for packet switching) and/or a wired communication link (e.g. for circuit switching). Communication can be executed in accordance with the Cellular Vehicle-to-X (C-V2X) paradigm, as per LTE Standard Version 14, the 4G standard and/or the 5G standard. Additionally or alternatively, the communication unit, independently of the wireless network or the availability of sufficient capacities on the currently available wireless network, can communicate via another wireless interface, for example a WLAN. To this end, IST-G5 or IEEE 802.11p can be employed in Vehicle-to-Vehicle (V2V) communication. The communication unit can thus receive data from other communication partners, e.g. the backend, or transmit data to other communication partners. In particular, the communication unit can receive video games or computer games from the backend.

In another example, the video game can be saved in a memory unit and retrieved by way of components of the in-vehicle infotainment system, for example by way of an integrated games console, gaining applications or apps which, in a manner which is known from the prior art, can be loaded and executed in the vehicle for the output of corresponding video games via output units in the vehicle, e.g. using a video games app.

The device comprises a display adaptation unit, which is designed to adapt the video game for output via at least two output units in the vehicle.

Adaptation of the video game comprises the identification of the pure gaming content of the actual video game. The gaming content thus identified is assigned by the display adaptation unit to a primary output unit of the vehicle. The primary output unit can comprise a screen or display, together with further relevant elements, e.g. loudspeakers, etc., of an in-vehicle infotainment system. Adaptation of the video game comprises the identification of additional information content of the video game. Additional information content can comprise a current game status of the video game and/or a current number of lives of the game player in the video game and/or information on further players of the video game and/or further additional information, which is typical of a video game. Additional information content of the video game thus identified is exported to a virtual desktop. The display unit is designed to assign the virtual desktop to an auxiliary output unit of the device or the vehicle, which is distinct from the primary output unit of the device or the vehicle. The auxiliary output unit can be a head-up display and/or a multimeter and/or any other output unit which is present in the vehicle.

The device comprises a control unit. The control unit can comprise a computing unit and a memory unit. The control unit is designed to control the primary output unit such that the primary output unit delivers an output of the pure gaming content thus identified. The primary output unit is further designed to control the auxiliary output unit such that the latter delivers an output of the additional information content of the virtual desktop which is assigned thereto.

Advantageously, it is thus ensured that the output of pure gaming content is delivered via the primary output unit of the device or the vehicle. This enhances convenience for the user(s) of the vehicle during the playing of the video game, as a representation of the video game in the manner which is known from the prior art is restricted by the dimensions of the primary output unit. In particular, the representation of additional information content of the video game on the primary output unit can thus be barely perceptible to the gamer, as described hereinafter with reference to FIG. 3A. Moreover, the representation of additional information content limits available space for the representation of actual gaming content on the primary output unit. By the representation of additional information content on an auxiliary output unit, the latter can be conveniently consulted by the player of the video game on the auxiliary output unit, as described hereinafter with reference to FIG. 3B. Moreover, the player can focus on the pure gaming content.

Identification of gaining content and additional information content is preferably executed by the evaluation of video game metadata.

According to a second aspect, the fundamental object is fulfilled by a vehicle comprising a device as described herein.

According to a third aspect, the fundamental object is fulfilled by a method for the vehicle-optimized representation of the relevant content of a video game via a plurality of output units in a vehicle, comprising:
adaptation, by way of a display adaptation unit, of the video game for output on at least two in-vehicle output units, comprising:
   identification of the gaming content of the video game;
   assignment of the gaming content thus identified to a primary output unit of the vehicle:
   identification of additional information content of the video game;
   exporting of the additional information content of the video game to a virtual desktop; and
   assignment of the virtual desktop to an auxiliary output unit of the vehicle;
control, by way of a control unit, of the primary output unit such that the latter delivers an output of the gaming content thus identified; and
control, by way of the control unit, of the auxiliary output unit such that the latter delivers an output of the additional information content of the virtual desktop which is assigned thereto.

Identification of gaming content and the identification of additional information content is preferably executed by the evaluation of video game metadata.

According to a fourth aspect, the fundamental object is fulfilled by a computer program product having program code which is designed, by the running thereof on a computing device or a computer, to execute a method as described herein.

According to a fifth aspect, the fundamental object is fulfilled by a computer-readable data medium containing program code of a computer program which is designed, by the running thereof on a computing device or a computer, to execute a method as described herein.

The above, together with other functions, features and advantages of the invention, will be clarified by an analysis of the following detailed description of preferred embodiments and the attached figures. It is evident that—notwithstanding the separate description of embodiments—individual features thereof can be combined in further embodiments.

### BRIEF DESCRIPTION OF THE DRAWINGS

FIG. 1 shows a schematic representation of a device for the vehicle-optimized representation of the relevant content of a video game via a plurality of output units of a vehicle.

FIG. 2 shows an exemplary method for the vehicle-optimized representation of the relevant content of a video game via a plurality of output units of a vehicle.

FIG. 3A shows a schematic representation of a video game display via a primary output unit of the vehicle, according to the prior art.

FIG. 3B shows a schematic illustration of the vehicle-optimized representation of the relevant content of a video game via a plurality of output units of a vehicle.

### DETAILED DESCRIPTION OF THE DRAWINGS

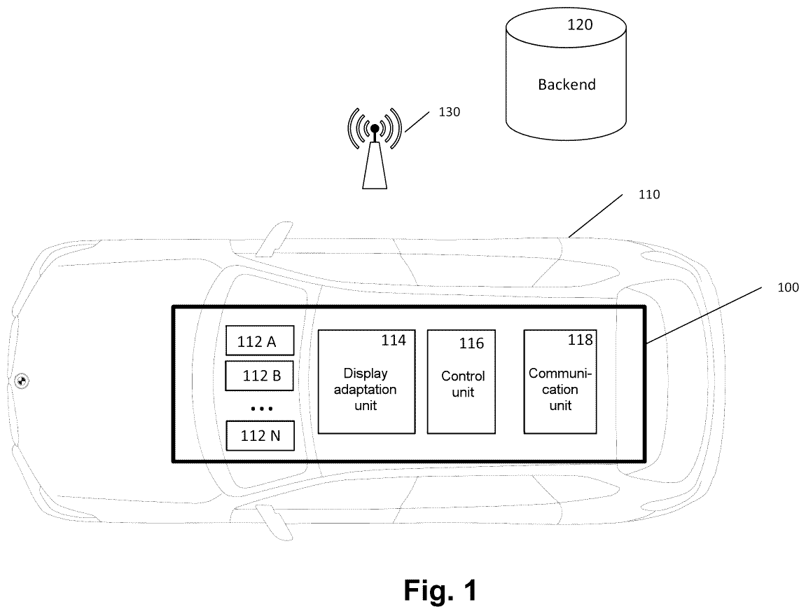

FIG. 1 shows a schematic representation of a device 100 for the vehicle-optimized representation of the relevant content of a video game via a plurality of output units 112 A . . . 112 N in a vehicle 110.

The device 100 comprises a plurality of output units 112 A . . . 112 N, which are designed for the visual or audio-visual output of information content in the vehicle 110.

A video game, in a manner which is known from the prior art, can be streamed and/or downloaded into the device 100 or the vehicle 110 via a backend 120 facility, and saved in a memory unit for the playback of the video game.

To this end, the device 100 or the vehicle 110 can comprise a communication unit 118. The communication unit 118 can comprise a Subscriber Identity Module or SIM card, the function of which is the set-up of a communication link via a wireless system or wireless network 130. The Subscriber Identity Module unambiguously identifies the communication unit 118 in the wireless network. The communication link can be a data connection (e.g. for packet switching) and/or a wired communication link (e.g. for circuit switching). Communication can be executed in accordance with the Cellular Vehicle-to-X (C-V2X) paradigm, as per LTE Standard Version 14, the 4G standard and/or the 5G standard. Additionally or alternatively, the communication unit 118, independently of the wireless network or the availability of sufficient capacities on the currently available wireless network, can communicate via another wireless interface, for example a WLAN. To this end, IST-G5 or IEEE 802.11p can be employed in Vehicle-to-Vehicle (V2V) communication. The communication unit 118 can thus receive data from other communication partners, e.g. the backend 120, or transmit data to other communication partners. In particular, the communication unit can receive video games from the backend 120.

In another example, the video game can be saved in a memory unit and retrieved by way of components of an infotainment system in the vehicle 110, for example by way of an integrated games console, gaming applications or apps which in the vehicle 110, in a manner which is known from the prior art, can be loaded and executed in the vehicle 110 for the output of corresponding video games via output units 112 A . . . 112 N in the vehicle 110, e.g. using a video games app.

The device 100 comprises a display adaptation unit 114, which is designed to adapt the video game for output via at least two output units 112 A . . . 112 N in the vehicle 110.

Adaptation of the video game comprises the identification of the pure gaming content of the actual video game. The gaming content thus identified is assigned by the display adaptation unit to a primary output unit 112 A of the vehicle 110. The primary output unit 112 A can comprise a screen or display, together with further relevant elements for the output of video games, e.g. loudspeakers, etc., of an in-vehicle infotainment system. Adaptation of the video game comprises the identification of additional information content of the video game. Additional information content can comprise a current game status of the video game and/or a current number of lives of the game player in the video game and/or information on further players of the video game and/or further additional information, which is typical of a video game. Additional information content of the video game thus identified is exported to a virtual desktop. The display unit 114 is designed to assign the virtual desktop to an auxiliary output unit 112 B . . . 112 N of the device 100 or the vehicle 110, which is distinct from the primary output unit 112 A of the device 100 or the vehicle 110. The auxiliary output unit 112 B . . . 112 N can be a head-up display and/or a multimeter and/or any other output unit which is present in the vehicle.

The device 110 comprises a control unit 116. The control unit 116 can comprise a computing unit and a memory unit. The control unit 116 is designed to control the primary output unit 112 A such that the primary output unit 112 A delivers an output of the pure gaining content thus identified. The control unit 116 is further designed to control the auxiliary output unit 112 B . . . 112 N such that the latter delivers an output of the additional information content of the virtual desktop which is assigned thereto.

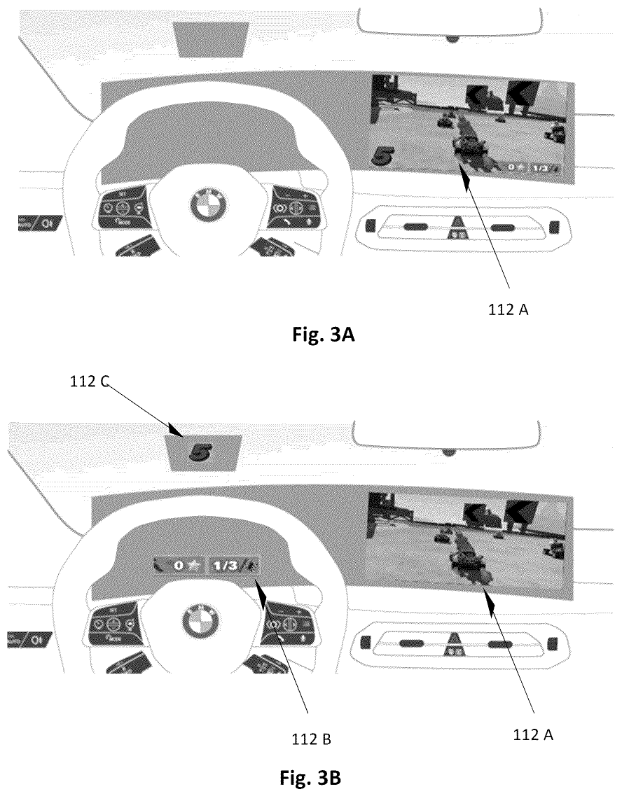

Advantageously, it is thus ensured that the output of pure gaming content is delivered via the primary output unit 112 A of the device 100 or the vehicle 110. This enhances convenience for the user(s) of the vehicle 110 during the playing of the video game, as a representation of the video game in the manner which is known from the prior art is restricted by the dimensions of the primary output unit 112 A. In particular, the representation of additional information content of the video game can thus be barely perceptible to the gainer. Moreover, the representation of additional information content limits available space for the representation of actual gaining content on the primary output unit 112 A, as described hereinafter with reference to FIG. 3A. By the representation of additional information content on the auxiliary output unit 112 B . . . 112 N, the latter can be conveniently consulted by the player of the video game on the auxiliary output unit 112 B . . . 112 N. Moreover, by the representation of pure gaming content on the primary output unit 112 A, the player can focus on the pure gaming content.

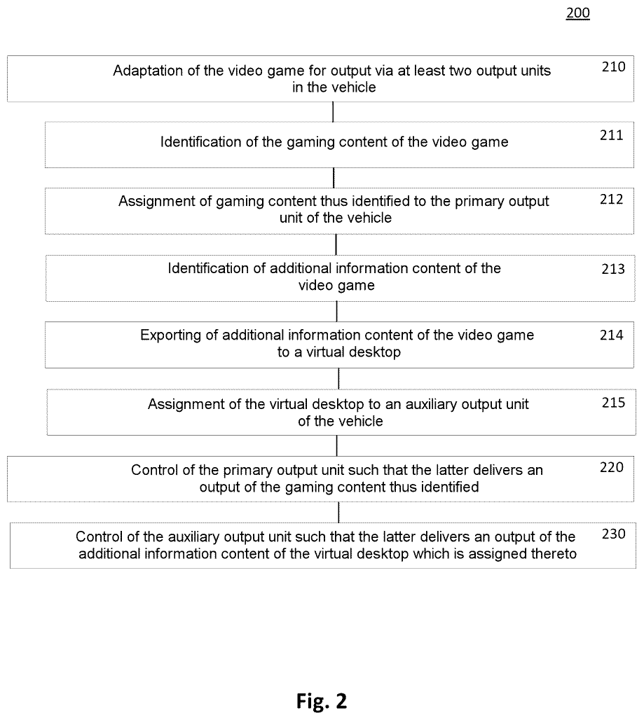

FIG. 2 shows a method 200 for the vehicle-optimized representation of the relevant content of a video game via a plurality of output units 112 A . . . 112 N in a vehicle 110, which can be executed by way of a device 100 as described with reference to FIG. 1.

The method 200 comprises:
adaptation 210, by way of a display adaptation unit 114, of the video game for output on at least two output units 112 A . . . 112 N of the vehicle 110, comprising:
   identification 211 of the gaining content of the video game;
   assignment 212 of the gaming content thus identified to a primary output unit 112 A of the vehicle 110:
   identification 213 of additional information content of the video game;
   exporting 214 of the additional information content of the video game to a virtual desktop; and
   assignment of the virtual desktop to an auxiliary output unit 112 B . . . 112 N of the vehicle 110;
control 220, by way of a control unit 116, of the primary output unit 112 A such that the latter delivers an output of the gaming content thus identified; and
control 230, by way of the control unit 116, of the auxiliary output unit 112 B . . . 112 N such that latter delivers an output of the additional information content of the virtual desktop which is assigned thereto.

Identification 216 of gaming content and the identification 213 of additional information content can be executed by the evaluation of video game metadata.

FIG. 3A shows a representation of a video game via a primary output unit 112 A of the vehicle 110, according to the prior art. In this case the screen of an infotainment system of the vehicle 110. The restriction of the representation of the video game is dictated by the dimensions of the primary output unit 112 A. In particular, output of the full content of the video game is delivered via the primary output unit 112 A. The representation of the additional information content of the video game, firstly, is barely perceptible and, secondly, representation of the additional information content restricts the available space for the representation of actual gaming content via the primary output unit 112 A. This is inconvenient for the player of the video game.

FIG. 3B shows a schematic illustration of a vehicle-optimized representation of the relevant content of a video game via a plurality of output units 112 A, 112 B, 112 C in a vehicle 110, which can be generated by way of a device 100 and a method 200 as described with reference to FIGS. 1 and 2. Output of gaming content of the video game is delivered via the primary output unit 112 A, in this case the screen of an infotainment system of the vehicle 110. An additional element of information content of the video game is a current round number, round 1 of 3. Output of additional information content is delivered via the auxiliary output unit 112 B, in this case a multimeter of the vehicle 110. A second additional element of information content is a current ranking of the gamer, in 5^{th} place. Output of this further additional information content is delivered via a further auxiliary output unit 112 C, in this case a head-up display of the vehicle 110.

Advantageously, representation of the actual gaming content can thus be executed via the primary output unit 112 A, wherein additional information content can conveniently be consulted by a game player via the auxiliary output units 112 B and 112 C. This enhances convenience for the player of the video game, or for the user of the vehicle 110 during the playing of the video game.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for vehicle-optimized representation of relevant content of a video game via a plurality of output units of a vehicle, the device comprising:
a display adaptation unit, which is configured to adapt the video game for output via at least two output units of the plurality of output units of the vehicle by:
identifying gaming content of the video game;
assigning the gaming content to a primary output unit of the plurality of output units of the vehicle;
identifying additional information content of the video game;
exporting the additional information content of the video game to a virtual desktop; and
assigning the virtual desktop to an auxiliary output unit of the plurality of output units of the vehicle; and
a control unit, which is configured:
to control the primary output unit such that the primary output unit delivers an output of the gaming content; and
to control the auxiliary output unit such that the auxiliary output unit delivers an output of the additional information content of the virtual desktop which is assigned to the auxiliary output unit.

2. The device according to claim 1, wherein identifying the gaming content and the additional information content is executed by evaluating video game metadata.

3. A vehicle comprising the device according to claim 1.

4. A method for vehicle-optimized representation of relevant content of a video game via a plurality of output units of a vehicle, the method comprising:
adapting, by way of a display adaptation unit, of the video game for output on at least two output units of the plurality of output units of the vehicle, comprising:
identifying gaming content of the video game;
assigning the gaming content to a primary output unit of the plurality of the output units of the vehicle;
identifying additional information content of the video game;
exporting the additional information content of the video game to a virtual desktop; and
assigning the virtual desktop to an auxiliary output unit of the plurality of output units of the vehicle;
controlling, by way of a control unit, the primary output unit such that the primary output unit delivers an output of the gaming content; and
controlling, by way of the control unit, the auxiliary output unit such that the auxiliary output unit delivers an output of the additional information content of the virtual desktop which is assigned to the auxiliary output unit.

5. The method according to claim 4, wherein identifying the gaming content and the additional information content is executed by evaluating of video game metadata.

6. A computer product comprising a non-transitory computer readable medium having stored thereon program code which, when executed on a computing device, carries out the method according to claim 4.
